(19) United States
(12) Patent Application Publication
(10) Pub. No.: US 2026/0070534 A1
(43) Pub. Date: Mar. 12, 2026

(54) TENSIONING MODULE FOR AN ELECTROMECHANICAL WHEEL BRAKE AND ELECTROMECHANICAL BRAKE DEVICE

(71) Applicant: Continental Automotive Technologies GmbH, Hannover (DE)

(72) Inventors: I-Che Chiang, Frankfurt am Main (DE); Marco Besier, Bad Schwalbach (DE); Dirk Pauly, Frankfurt am Main (DE); Mathias Haag, Darmstadt (DE); Sven Rückert, Reinheim (DE)

(73) Assignee: Continental Automotive Technologies GmbH, Hannover (DE)

(21) Appl. No.: 19/316,637

(22) Filed: Sep. 2, 2025

(30) Foreign Application Priority Data
Sep. 9, 2024 (DE) 10 2024 208 558.8

(51) Int. Cl. B60T 13/74; F16D 65/18; F16D 121/24; F16D 125/40

(52) U.S. Cl. CPC B60T 13/746; F16D 65/18; F16D 2121/24; F16D 2125/40; F16D 2250/0061

(57) ABSTRACT

The embodiments relate to a tensioning module for an electromechanical wheel brake and to an electromechanical brake device. The tensioning module is used to move a brake piston in the electromechanically operable wheel brake, e.g. of a motor vehicle. The tensioning comprises a ball screw drive, a piston, and an axial bearing. The ball screw drive comprises a spindle and a nut. The spindle comprises a threaded portion and a drive portion. The threaded portion and the drive portion are produced as separate components and are connected to one another fixedly for conjoint rotation.

### TECHNICAL FIELD

The embodiments relate to a tensioning module for an electromechanical wheel brake and to an electromechanical brake device having such a tensioning module. The tensioning module is used to move a brake piston in the electromechanically operable wheel brake of a motor vehicle.

### BACKGROUND

Electromechanical wheel brakes are now used in modern motor vehicles, and are increasingly also used as service brakes. These wheel brakes offer a number of differences over conventional, hydraulically operated wheel brakes. For instance, there is no longer any need for a complex hydraulic system, and an electromechanical wheel brake also occupies less space.

Electromechanical wheel brakes of this type typically have an electronic drive unit which interacts with a mechanism or a gear unit. A brake unit can then be arranged on the output side, and this can comprise, for example, a brake piston and a friction pad which can be pressed onto a rotating friction partner by means of translational movement. It is thereby possible to bring about deceleration during operation.

To this end, the drive unit typically comprises at least one electric motor which has a correspondingly high output density. The mechanical connection to the friction brake can then be established by means of at least the gear mechanism. In addition to factors such as efficiency and rigidity, above all the mechanical design, the installation space requirement and the transmission characteristic determine the potential applications of the wheel brake.

Appropriate mechanisms are known for converting the rotational movement of the electric motor to the required translational or linear movement. A known mechanism is, for example, a rotational-translational movement converter comprising a so-called ramp mechanism or a ramp unit.

An alternative mechanism can be seen in ball screw drives. These do not offer the option of nonlinear power transmission. On the other hand, however, complex wear compensation does not need to be provided, as the effective stroke may be longer than with rotational-translational movement converters with a ramp mechanism.

Known electromechanical brake devices with a ball screw drive as rotational-translational movement converter are therefore of a relatively long construction to cover comparatively longer displacements, also with regard to wear compensation, this however being potentially contrary to the installation situation and the space requirement. The installation space in the case of electromechanically actuated service brake units is more critical than, for example, in the case of parking brake units.

If such a tensioning module is to be used, for example, for an electromechanically actuable disk brake as a service brake, the extent in the axial direction is relatively large. This can lead to challenges with such electromechanically actuable disk brakes, e.g. when they are to be integrated into the front axles of a motor vehicle. The steering lock at the front axles in particular makes it desirable to have as little axial overall length as possible in order to be able to integrate electromechanically actuable disk brakes into today's car front axle installation spaces. The axial overall length of electromechanically actuable disk brakes is therefore of import and thus to be reduced to the lowest possible extent.

In previous designs of ball screw drives, such as those integrated, for example, into parking brakes, there is generally not provided any antirotation safeguard of the nut of the ball screw drive or the piston to prevent rotation thereof toward the caliper housing. However, without a positive antirotation safeguard between the nut and the caliper housing, there can occur an uncontrolled rotation of components of the ball screw drive, for instance the nut or the piston relative to the caliper housing. In other words, the nut and/or piston may rotate unintentionally, for example in relation to the caliper housing. This can result in the fact that the rotation angle of the spindle or of the motor can no longer be assigned a clear axial position of the piston and/or of the nut. As a result, difficulties can arise with regard to the controllability of the tensioning module or of the electromechanical brake.

Therefore, having a tensioning module, for an electromechanical brake device, which at least mitigates the abovementioned drawbacks is desirable. The tensioning module may be equipped with a ball screw drive here.

Further it is useful here if the number of components required can be reduced. Moreover, possible modularity in terms of construction and in the individual components, as well as easy assembling of the individual parts and components, is also useful. The required components, for example the spindle of the ball screw drive, should also be able to be produced as cost-effectively as possible.

### SUMMARY

This object is achieved by a tensioning module, an electromechanical brake device, in particular for a motor vehicle, and a motor vehicle as claimed in one of the independent claims. Preferred embodiments and developments can be gathered from the respective subclaims.

In a first aspect, a tensioning module, for example for an electromechanical brake device for a motor vehicle, comprising a ball screw drive, a piston, an axial bearing, wherein the ball screw drive comprises a spindle and a nut, wherein the spindle comprises a threaded portion and a drive portion, and wherein the threaded portion and the drive portion are produced as separate components and are fixedly connected to one another.

The spindle can be mounted by the axial bearing in the housing, for example a caliper housing of a motor vehicle brake.

One embodiment also provides a stop bearing washer which is arranged at an axial end of a radial widening of the spindle, wherein the axial bearing is arranged on the opposite side of the stop bearing washer to the piston.

A further aspect, also relates to an electromechanical brake device, for example an electromechanically actuable wheel brake, e.g. an electromechanically actuable disk brake, comprising such a tensioning module.

Finally, the embodiments also relate to a motor vehicle, comprising at least one electromechanical brake device having at least one tensioning module as described above.

Within the context of the embodiments, a motor vehicle means a vehicle having axles, wherein at least one of these axles can comprise steerably guided wheels and, furthermore, the drive of the wheels of at least one axle can be adapted in a wheel-specific manner.

The electromechanically actuable wheel brakes of the electromechanical brake device can be embodied as electromechanical disk brakes, for example for both front and rear axle applications in motor vehicles.

The electromechanical brake device can comprise an electric motor to drive the spindle. This can generate a drive torque for actuating the wheel brakes. The drive torque can be transferred from the electric motor to the spindle via a suitable gear mechanism.

The configurations of an electromechanical brake device described below are shown purely by way of example using the example of an electromechanical disk brake for setting defined brake application forces. A transfer to an electromechanical drum brake for setting defined spreading forces or braking torques is possible for a person skilled in the art without any problems.

With reference to the brake device, the brake application direction, that is to say an axial direction, in which the piston is moved to generate a brake force, is hereinafter referred to as the piston side or piston-proximal, whereas the opposite direction, and consequently the release direction, in which the drive unit can be located in an extension of the spindle, is also referred to as the drive side of the brake device or drive-proximal.

The electromechanical disk brakes can be embodied in such a manner that a brake application force can be generated by means of the electric motor, a gear mechanism and a rotational-translational movement converter. The brake application force in this case refers to the force with which the brake pads are pressed against the brake disk, then produces a corresponding braking torque at the wheel in question. Depending on the embodiment and closed-loop control concept, the actuation of the electromechanical disk brakes can be designed in such a way that either a specified, defined clamping force or a specified, defined braking torque can be set in accordance with the deceleration demand requested.

The electromechanically actuable drum brakes may be embodied so that a motor/gear unit actuates an expansion module which presses the brake pads against the brake drum with a spreading force predetermined on the basis of the desired deceleration requested and thus produces a corresponding braking torque.

The tensioning module can comprise a caliper housing in the style of common designs for disk brake housings or can be integrated into such a caliper housing, for example a floating caliper brake or a sliding caliper brake. The caliper housing can also be designed here as a multi-piston unit or multi-piston caliper and can comprise more than one tensioning module, for example two tensioning modules. In this way, the caliper housing can be designed, for example, as a two-piston sliding caliper. The caliper housing can comprise corresponding brackets for mounting friction pads for the realization of a disk brake.

Accordingly, a tensioning module of the aforementioned type is provided, wherein the spindle, the stop bearing washer and the axial bearing can be formed as separate components. The tensioning module can further comprise the piston and an antirotation safeguard means, e.g. an antirotation safeguard element. This enables an easy mounting capability with high modularity at the same time.

The tensioning module allows an antirotation safeguard means and a tangential rotation stop to be implemented in a single component or in a single assembly. The assembly can therefore comprise the nut, the spindle, the stop bearing washer and/or the axial bearing. This makes it possible to implement the required functions with a very small number of components. This also reduces the axial length of the tensioning module.

According to one embodiment, the spindle can be mounted in the housing by the axial bearing. The axial bearing can be arranged in such a way that it can absorb axial forces, which can arise during brake application, and can transfer them to the housing. The spindle can have a radially projecting, e.g. annular stop which makes it possible to transfer the axial forces first of all to the stop bearing washer and from this to the axial bearing.

According to one embodiment, the spindle can therefore have a piston-proximal threaded portion and a drive-proximal drive portion, wherein the drive portion can have a smaller cross-sectional area than the threaded portion, so that the annular stop is formed, which provides the abovementioned piston-proximal stop surface for the stop bearing washer. For example, the axial bearing can be embodied as a single-row or double-row cylindrical roller bearing.

The brake application force can be applied by means of the nut and the spindle, which thus act as a rotational-translational movement converter. Based on a drive torque of an electric motor, which may be transmitted to the spindle via suitably designed gear units, the piston can be moved by means of the nut in an axial movement relative to the housing. In this way, friction pads can be moved toward and pressed against a rotating element, e.g. a brake disk, to generate a predetermined braking torque. The piston can therefore be designed to be concomitantly axially displaceable by an axial displacement of the nut.

The piston can be connected here to the housing by an elastic ring element, wherein the elastic ring element can be configured to be so elastically deformable that a relative axial displacement of the housing and piston is made possible. In this way, a gap or intermediate space present between the housing and piston can be sealed against the ingress of particles or other substances.

In order to be able to carry a large axial load and/or at the same time allow a very compact design in the axial direction, it is useful if the diameter of the spindle is rather large. On the other hand, however, the diameter of the drive portion of the spindle can be chosen to be rather small, so that, among other things, the axial bearing can be plugged on. These geometrical requirements for the spindle can result in the outside diameter of the drive portion of the spindle becoming small in comparison with the outside diameter of the threaded portion of the spindle. This can be adverse for the production of the spindle, for example by means of cold forming. However, alternative production, such as machining, is associated with high costs.

Accordingly, it is therefore provided to embody the spindle in two parts. In other words, the spindle can comprise a threaded portion and a drive portion, wherein the threaded portion and the drive portion are produced as separate components and can then be connected to one another fixedly, for example fixedly for conjoint rotation. The term “fixedly for conjoint rotation” means that a torque can be transmitted without slip. This makes it possible to select the respective optimal production process for the respective portions of the spindle.

Moreover, different materials can also be selected for the two portions. For example, a material with different stiffness characteristics and higher surface hardness can be selected for the threaded portion in comparison with the drive portion, in which the relevant requirements may be lower. Appropriate steel alloys are available as material.

The threaded portion and the drive portion of the spindle can be connected to one another in an integrally bonded manner.

The threaded portion and the drive portion of the spindle can be connected to one another in a non-positive manner.

The threaded portion and the drive portion of the spindle can also be positively connected to one another.

A combination, for example a positive connection together with a non-positive connection, implemented for example as a spline system in combination with a press fit, can be constructive.

For this purpose, for example, the threaded portion can comprise an internal spline system on its drive-proximal region. The drive portion can comprise an external spline system on its piston-proximal region. The external spline system and the internal spline system can be of mating design. For connection, the drive portion with its external spline system can be inserted into the internal spline system, so that a positive fit is created. A press fit between the threaded portion and the drive portion can then additionally be provided to prevent against loosening.

This allows the drive portion to have a much smaller outside diameter than the threaded portion. As a result, an annular stop can also be formed, which can provide a piston-proximal stop surface, for example for the stop bearing washer.

In this way, for example, a spindle can be produced in which the following relationship applies to the outside diameter of the threaded portion D_{G} of the spindle in comparison with the outside diameter of the drive portion of the spindle D_{A}: D_{G}>1.3*D_{A}, for example D_{G}>1.5*D_{A}, e.g. D_{G}>1.7*D_{A}. The respective outside diameters can therefore be adapted to the respective functionality.

According to one embodiment, various functions can be integrated into a component. In this way, the number of components of the tensioning module can be reduced and the design simplified.

Thus, for example, the stop bearing washer can be substantially annular with a through hole in order to be able to be plugged onto the spindle. For a fixed connection to the spindle for conjoint rotation, the stop bearing washer can have a spline system, e.g. an internal spline system, in the region of the through hole.

According to a development, the stop bearing washer and/or the drive portion can be formed as a one-piece, monolithic component.

Other forms of a rotationally conjoint connection between the stop bearing washer and the spindle are also possible, for example a a spline system by means of an external spline system of the drive portion, for example in the extension of a spline system for the rotationally conjoint connection to the threaded portion.

Furthermore, the stop bearing washer can comprise a centering collar on the end face pointing toward the piston, which can facilitate the fitting to the spindle with an accurate fit.

According to a further embodiment, the stop bearing washer can comprise a radially projecting shoulder. As a result, an end stop may be provided, by way of which an end position of the actuator can be detected.

According to a further embodiment, an antirotation safeguard means can also be provided. The antirotation safeguard means can comprise an antirotation safeguard element or a securing element.

The antirotation safeguard element can have at least one of the following features. It can be formed as a substantially annular or annular element with a through hole, in order to be able to be plugged onto the nut and connected to the nut fixedly for conjoint rotation. The antirotation safeguard element can further comprise a radially projecting attachment which can engage in a recess or groove to bring about antirotation safeguarding. Furthermore, the antirotation safeguard element can comprise a pin, which may project axially in the opposite direction to the piston in relation to the end face. The pin can be arranged to this end on the attachment and can have a stop for the radially projecting shoulder in a determined rotational position of the stop bearing washer.

Another embodiment can comprise as antirotation safeguard means a securing element, for example a pin or nail, which can be arranged, for example, between the nut and the housing and/or the piston.

By means of the design of the proposed assembly or the electromechanical brake device, a reliable and safe operation of the tensioning module and thus of an electromechanically actuable wheel brake, for example an electromechanically actuable disk brake, equipped therewith can be ensured, wherein a positive antirotation safeguard of the nut and/or the piston with respect to the surrounding housing, for example the caliper housing of a wheel brake, can be provided.

The angle of rotation of the motor and the spindle may always be assigned a unique axial piston stroke here, and thus a reliable function and control of the piston stroke can be made possible with the help of electronics and suitable software. The electronics and software can be provided in a drive unit, which can be connected to the housing. The drive unit can further comprise the electric motor and/or a gear mechanism or transmission gear for driving the tensioning module.

The antirotation safeguard means can realize two functions; it can provide on the one hand a positive antirotation safeguard with respect to the surrounding housing, for example caliper housing, and on the other hand a tangential rotary stop of the spindle and nut.

### BRIEF DESCRIPTION OF THE DRAWIGNS

Further details are apparent from the description of the illustrated exemplary embodiments and the attached claims.

In the drawings:

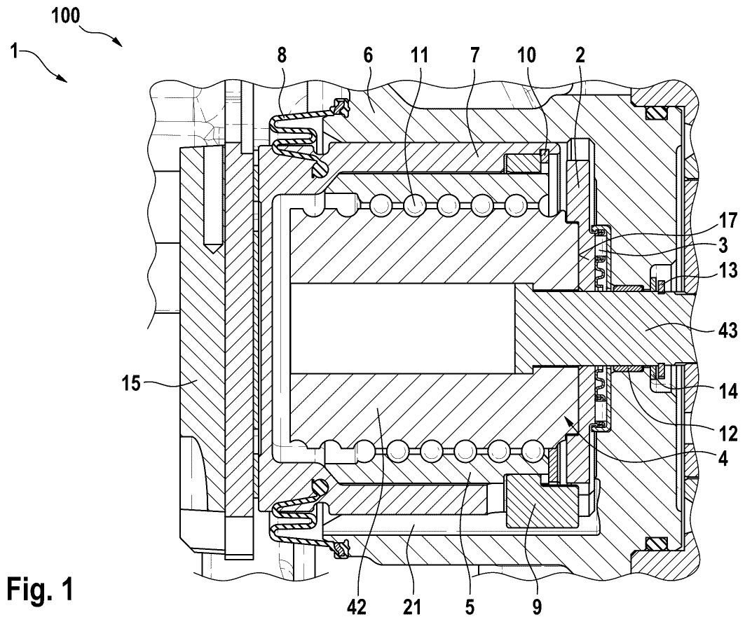

FIG. 1 shows a sectional view of an exemplary tensioning module according to a first embodiment,

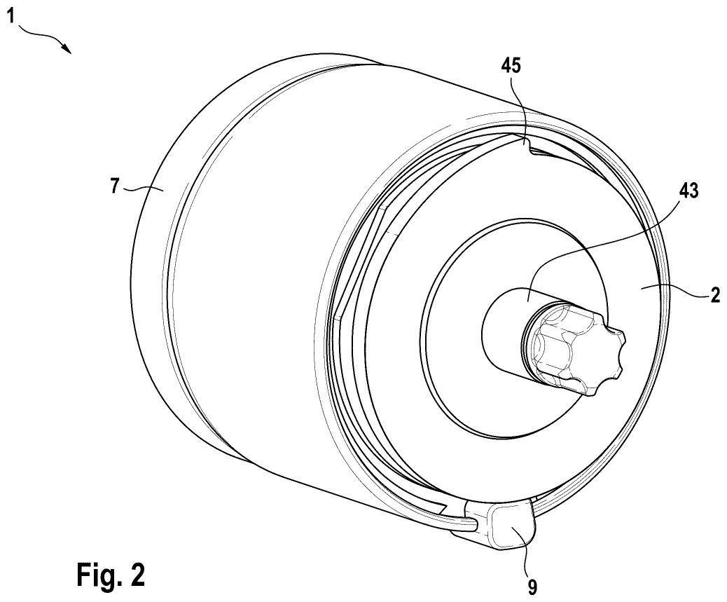

FIG. 2 shows an outside view of the tensioning module from FIG. 1,

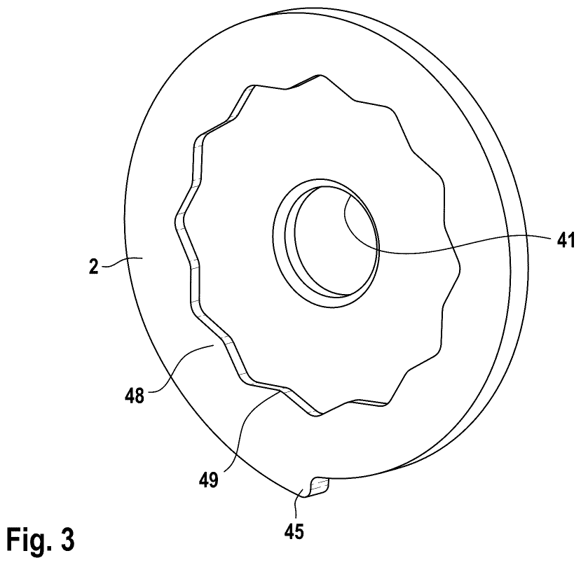

FIG. 3 shows a stop bearing washer of the tensioning module from FIG. 1 in an oblique view,

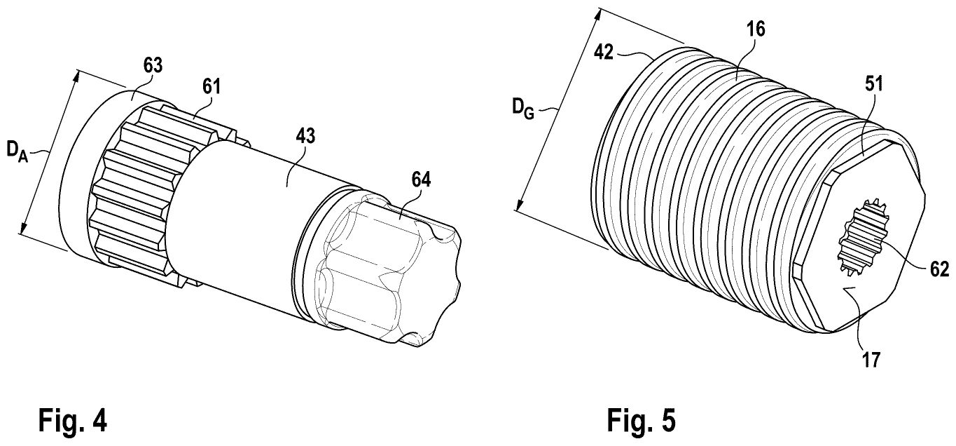

FIG. 4 shows a drive portion of the spindle of the tensioning module from FIG. 1 in an oblique view,

FIG. 5 shows a threaded portion of the spindle of the tensioning module from FIG. 1 in an oblique view,

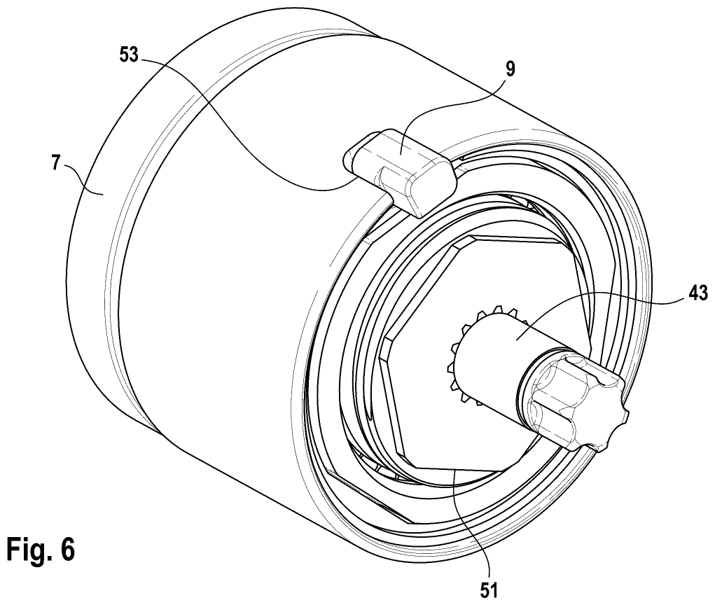

FIG. 6 shows an outside view of the tensioning module from FIG. 1 without the stop bearing washer,

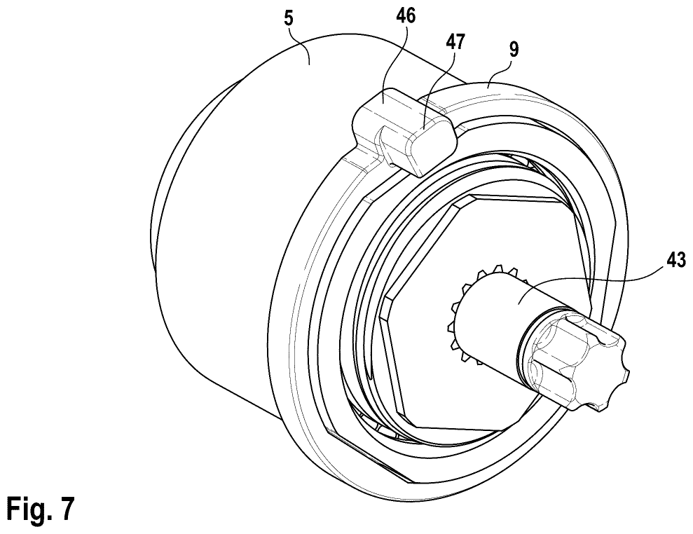

FIG. 7 shows a ball screw drive of the tensioning module in accordance with FIG. 6 without a housing and a more visible antirotation safeguard means,

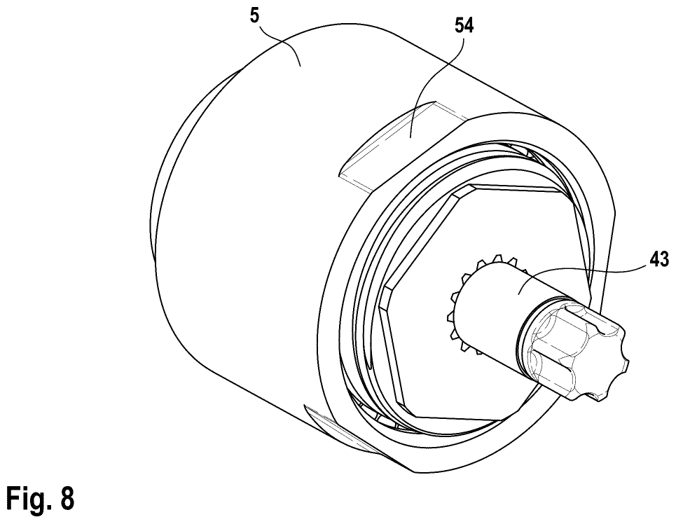

FIG. 8 shows a ball screw drive of the tensioning module in accordance with FIG. 5 without an antirotation safeguard means,

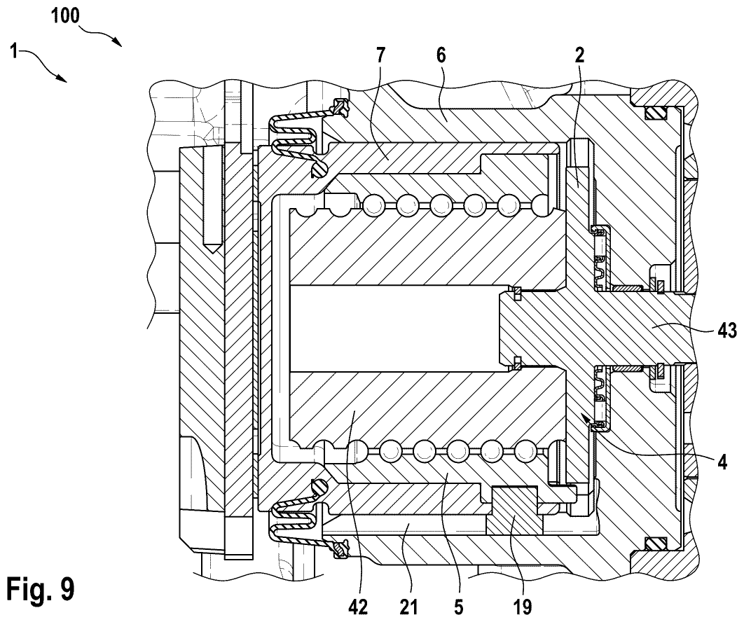

FIG. 9 shows a sectional view of a tensioning module according to a further embodiment,

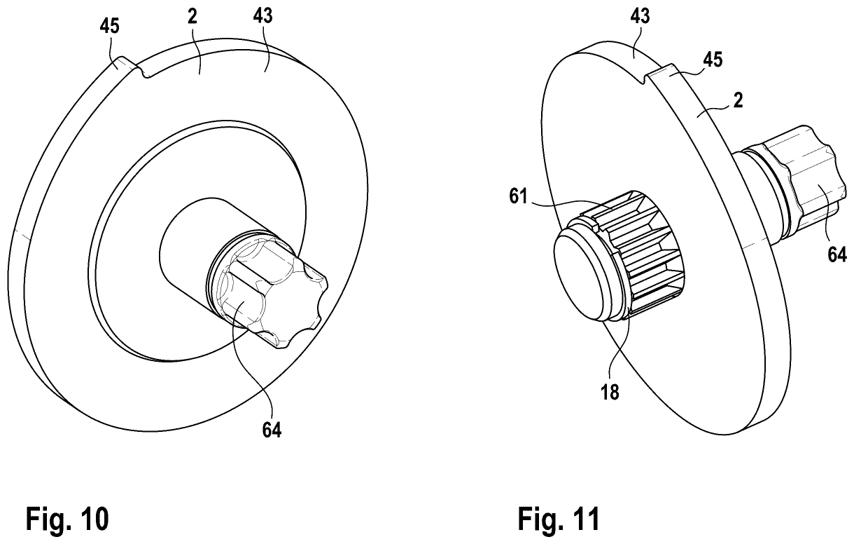

FIG. 10 shows a drive unit of the spindle of the tensioning module from FIG. 9 in an oblique view,

FIG. 11 shows a drive unit of the spindle of the tensioning module from FIG. 9 in a further oblique view,

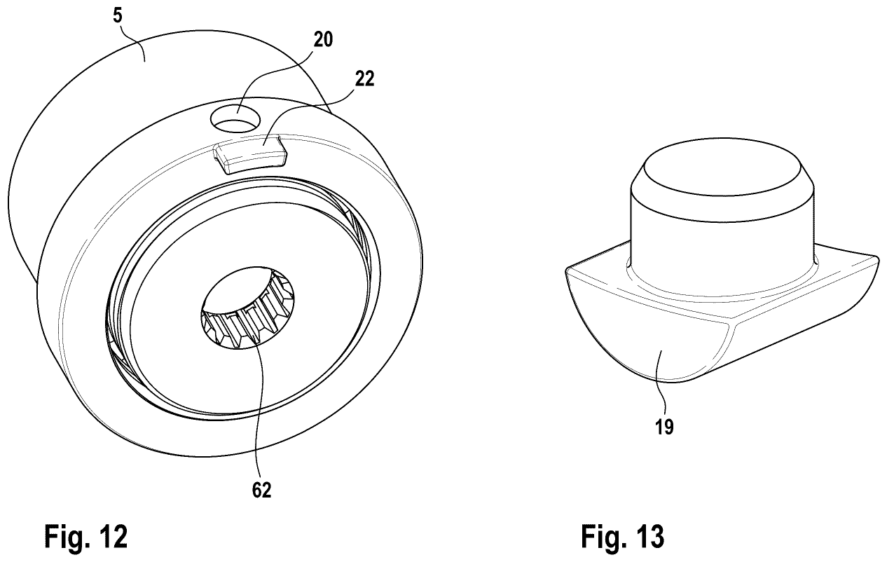

FIG. 12 shows a threaded portion of the spindle of the tensioning module from FIG. 9 in an oblique view,

FIG. 13 shows a securing element of the tensioning module from FIG. 9 in an oblique view,

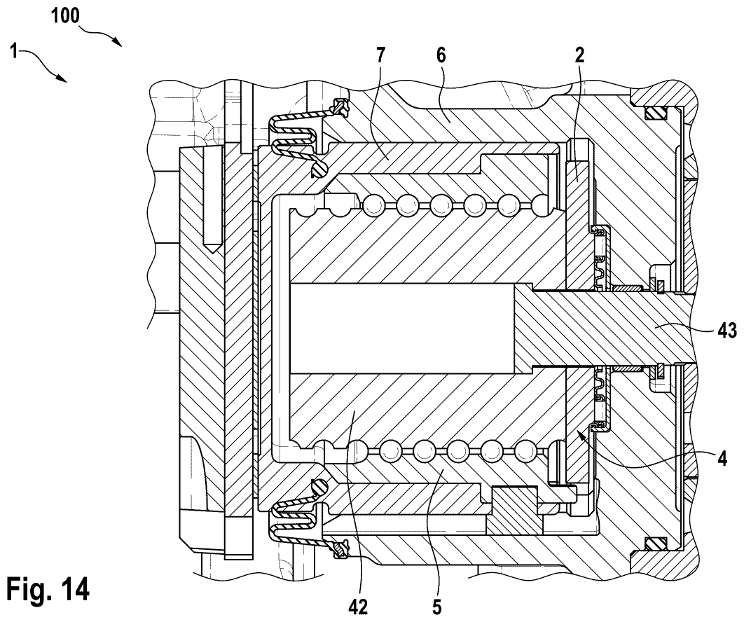

FIG. 14 shows a sectional view of a tensioning module according to yet a further embodiment,

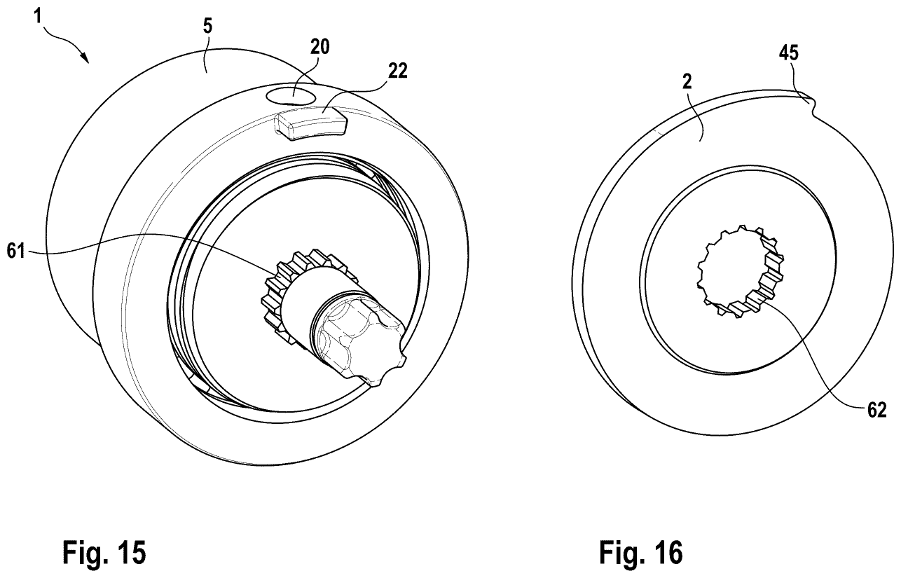

FIG. 15 shows a ball screw drive of the tensioning module in accordance with FIG. 14 without an antirotation safeguard means,

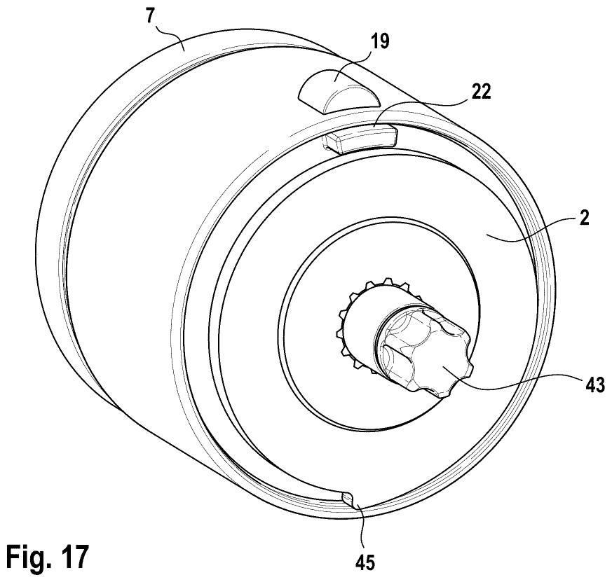

FIG. 16 shows a stop bearing washer of the tensioning module from FIG. 14 in an oblique view, and

FIG. 17 shows an outside view of the tensioning module from FIG. 14.

### DETAILED DESCRIPTION

In the following detailed description of the embodiments, for the sake of clarity, the same reference signs denote substantially identical parts in or on these embodiments. However, for better clarification, the embodiments illustrated in the figures are not always drawn to scale. For reasons of clarity, only those elements which are relevant for understanding the embodiment of the approach are illustrated here.

FIGS. 1, 9 and 14 show possible embodiments of a tensioning module 1 according to the invention. The tensioning module 1 is suitable, for example, for an electromechanical brake device 100 for a motor vehicle and comprises a ball screw drive, a piston 7, and an axial bearing 3, wherein the ball screw drive comprises a spindle 4 and a nut 5, wherein the spindle 4 comprises a threaded portion 42 and a drive portion 43, and wherein the threaded portion 42 and the drive portion 43 are produced as separate components and are connected fixedly, for example fixedly for conjoint rotation, to one another.

A caliper housing 6, shown only in sections in FIG. 1, is provided for receiving the tensioning module 1 and is accordingly designed for this purpose. In the caliper housing 6, the spindle 4 is supported by the axial bearing 3.

In FIG. 1, the tensioning module 1 further comprises a stop bearing washer 2,
wherein the stop bearing washer is arranged at an axial end of a radial widening of the spindle, for example at the transition between the threaded portion and the drive portion, and wherein the axial bearing is arranged on the opposite side of the stop bearing washer to the piston.

The rotational-translational movement converter of the tensioning module 1 is designed as a ball screw drive with a nut 5, a spindle 4 and balls 11 which can run in corresponding grooves of the nut 5 and/or the spindle 4.

The spindle 4 comprises a threaded portion 42, which comprises the grooves 16 on its shell surface. The spindle 4 further comprises a separately produced drive portion 43, which is connected to the threaded portion 42 for conjoint rotation. The drive portion 43 comprises a piston-proximal region which, viewed in the axial direction, overlaps with the threaded portion 42 and is designed to provide a rotationally conjoint connection to the threaded portion 42. Furthermore, the drive portion 43 comprises a drive-proximal region which projects on the drive side with respect to the piston 7 and/or the nut 5 and is routed through the stop bearing washer 2 and the axial bearing 3. This region is routed up to the drive unit.

The tensioning module 1 in the embodiment shown further comprises the piston 7. The piston 7 is arranged axially movably relative to the housing 6. The tensioning module 1 can comprise a drive unit with an electric motor and a transmission gear which is designed to generate a drive torque with which the spindle 4 can be subjected to a torque during operation. The drive portion 43 of the spindle 4 is therefore in operative connection with the transmission gear. The drive portion 43 has a smaller outside diameter than the threaded portion 42, so that it can be easily routed through the stop bearing washer 2 and the axial bearing 3.

Based on the drive torque of the drive unit, the piston 7 can be moved in an axial movement along its axis of rotation relative to the housing 6. The nut 5 is provided to transfer the force component to the piston 7 by means of an axial movement. In this way, the piston 7 can press friction pads 15 against a brake disk to generate a predetermined brake torque or a predetermined brake application force for the wheel brake in the case of a disk brake.

The piston 7 in the illustrated configuration is connected to the caliper housing 6 by an elastic ring element 8, wherein the elastic ring element 8 is so elastically deformable that a relative axial displacement of the caliper housing 6 and piston 7 is made possible.

FIG. 1 further shows a bushing 12 and a securing ring 13 as well as an adjusting washer 14 next to the securing ring 13. Furthermore, in the exemplary embodiment shown, an axial securing ring 10 is provided in the piston 7, which serves to be able to actively pull the piston 7 in the release direction with the aid of the nut 5.

FIG. 2 shows an outside view of the tensioning module 1 from FIG. 1.

FIG. 3 shows a stop bearing washer 2 of the tensioning module 1 from FIG. 1 in an oblique view, wherein the side surface facing the piston 7 is shown.

FIG. 4 shows a drive portion 43 of the spindle 4 of the tensioning module 1 from FIG. 1 in an oblique view.

FIG. 5 shows a threaded portion 42 of the spindle 4 of the tensioning module 1 from FIG. 1 in an oblique view.

In order to be able to carry a large axial load and at the same time allow a very compact design in the axial direction, the outside diameter of the threaded portion 42 of the spindle 4 is selected to be comparatively large. At the same time, however, the drive portion 43 of the spindle 4 is selected to be rather small so that the stop bearing washer 2 and the axial bearing 3 can be plugged on without having to accept a too strong weakening in these components owing to the required through opening.

A two-part spindle 4 is therefore provided. Accordingly, the threaded portion 42 and the drive portion 43 are produced as separate components. The threaded portion 42 and the drive portion 43 are then connected fixedly, for example fixedly for conjoint rotation, to one another in a subsequent joining process. This makes it possible to select the respectively optimal production method for the respective portions of spindle 4.

For a rotationally conjoint connection between the threaded portion 42 and the drive portion 43 of the spindle 4, a positive and/or non-positive connection is provided. Alternatively or additionally, an integrally bonded connection is also possible.

In the exemplary embodiment of FIG. 4, the drive portion 43 of the spindle 4 is formed with an external spline system 61 and a collar 63 on the piston-proximal region. In the embodiment of FIG. 5 there can be seen an internal spline system 62 of the threaded portion 42, which comprises a portion of the inner wall of the through opening of the threaded portion 42 of the spindle 4.

In this way, a spindle 4 in which the outside diameter D_{G} of the threaded portion 42 of the spindle 4 is significantly smaller than the outside diameter D_{A} of the drive portion 43 of the spindle 4 can be made available. Thus, for example, a spindle 4 can be made available, wherein the following relationship applies to the outside diameter D_{G} of the threaded portion 42 of the spindle 4 in comparison with the outside diameter D_{A} of the drive portion 43 of the spindle 4: D_{G}>1.3*D_{A}, for example D_{G}>1.5*D_{A}, e.g. D_{G}>1.7*D_{A}. For the exemplary embodiment shown, the following applies for example: D_{G}≈3*D_{A}.

As a result, an annular stop surface 17 which can provide a stop for the stop bearing washer 2 can also be formed.

For assembly, the drive portion 43 can be inserted piston-proximally, accordingly in FIG. 5 from the left, into the threaded portion 42 until the collar 63 reaches a further stop on the inner wall. In this way, the external and internal spline system can enter into a positive operational relationship, and the threaded portion and drive portion are coupled to one another via the spline systems. Thus, a torque can be transferred from the drive portion 43 to the threaded portion 42 via the spline systems.

In addition, according to an embodiment, a press fit between the external and internal spline system is provided. In this way, the drive portion 43 and the threaded portion 42 of the spindle 4 can also be axially secured.

On the opposite side of the drive portion 43 of the spindle 4 to the external spline system 61, a further positive profile 64 is formed. In the exemplary embodiment shown in FIG. 4, a Torx profile is shown purely as an example. With this profile 64, the drive portion 43 of the spindle 4 can be coupled to an output of a gear mechanism so that a torque can be transmitted.

For further mounting of the tensioning module 1, this can be inserted into the housing 6, after which the tensioning module 1 and the drive portion 43 are axially secured in the housing by a securing ring 13.

The tensioning module 1 further comprises the stop bearing washer 2 and the axial bearing 3. FIG. 3 shows the stop bearing washer 2 in one embodiment in an oblique view. Accordingly, the stop bearing washer 2 combines the following functions in a very compact manner in a single component: it forms the running surface for the axial bearing 3 or the rolling bodies of the axial bearing 3, it forms the tangential rotary stop between the spindle 4 and the nut 5.

The stop bearing washer 2 is designed for this purpose according to this embodiment in such a way that it can be directly plugged at least partially onto the threaded portion 42 of the spindle 4 in the axial direction. The stop bearing washer 2 has a substantially annular shape with a through hole 41, through which the drive portion 43 of the spindle 4 can be guided.

In order to enable a fixed connection to the spindle 4 for conjoint rotation, a spline system 48 is provided on the end face pointing toward the threaded portion 42. This spline system 48, in the exemplary embodiment shown in FIG. 3 configured with 12 teeth 49 in a serrated form, may be realized on a large diameter as shown in FIG. 3 in order to achieve a relatively low tangential force in the spline system for the torques to be transferred.

As can be seen in FIG. 3, the spline system 48 represents a tapered region of the axial bearing washer 2 and is surrounded by a thicker, outer collar. In this way, the thickness of the axial bearing washer 2 and thus the length of the axial bearing washer 2 can be kept very low in the axial direction, since the low tangential force can be supported over a very narrow surface. According to an embodiment, the depth of the teeth, i.e. the extent in the axial direction, can comprise about half the thickness of the axial bearing washer 2. In this way, a greater torsional stress on the components is also possible.

For this purpose, the corresponding threaded portion 42 of the spindle 4 can have a matching counter-spline system or an external spline system 51 to obtain a positive connection after being plugged on axially. In this way, the drive torque can be safely transferred between the spindle 4 and the stop bearing washer 2.

Furthermore, the stop bearing washer 2 is formed with a radially projecting shoulder 45 which forms the tangential rotary stop between the stop bearing washer 2 and the nut 5 and/or the antirotation safeguard element 9 plugged on there for safeguarding against rotation.

FIG. 6 shows an outside view of the tensioning module according to the invention from FIG. 1 without the stop bearing washer 2. The external spline system 51 is clearly visible as a counter-contour to the contour of the stop bearing washer 2. In the exemplary embodiment, the external spline system 51 is configured as a hexagon external spline system on the spindle 4.

FIG. 7 shows a ball screw drive of the tensioning module 1 in accordance with FIG. 6 without the surrounding piston 7, with the result that the antirotation safeguard means is more visible.

FIG. 8 shows a ball screw drive of the tensioning module 1 in accordance with FIG. 5 without an antirotation safeguard means.

The antirotation safeguard element 9 is, as can also be seen from FIG. 1, arranged between the nut 5 and the piston 7 and the portion of the housing 6 surrounding the piston 7.

The antirotation safeguard element 9 is annular or formed as a substantially annular element. In this way, it can be plugged onto the nut 5 in the axial direction. The portion of the nut provided for this purpose can be designed to provide a positive and thus mutually rotationally conjoint connection between the antirotation safeguard element 9 and the nut 5. In the exemplary embodiment shown in FIG. 8, flattened portions 54 of the outer contour of the nut 5 are provided for this purpose, in the example a total of three such flattened portions 54, wherein even one such flattened portion 54 may suffice. The inner contour of the antirotation safeguard element 9 is of precisely mating design, so that a positive connection is created after assembly has occurred.

The antirotation safeguard element 9 comprises a radially projecting attachment 46. This attachment 46 can be received by a recess 53 of the piston 7, as can be seen in FIG. 6.

In the illustrated embodiment, the attachment 46 is of protruding design with respect to the outer shell surface of the piston 5 and is therefore guided through the corresponding portion of the piston 5, in order to be able to be guided further into the caliper housing 6. This enables a compact embodiment. The attachment 46 thus protrudes from the annular portion of the antirotation safeguard element 9 and the piston 5 to such an extent that it can engage in a recess of the housing 6, for instance a groove of precisely mating design, and can be guided axially in this. In this way, the antirotation safeguard means can be realized between the nut 5 and the housing.

The attachment 46 further comprises, at its radial end a projection or pin 47 which has a substantially axial orientation. The pin 47 protrudes axially with respect to the antirotation safeguard element 9 or the end face of the antirotation safeguard element 9 in a direction opposed to the piston. In this case, it does not project beyond the attachment 46 in the radial direction. This enables the following functions: the pin 47 forms the antirotation safeguard means of the nut 5 in the housing 6. To this end, the housing 6 is provided with a groove 21 of precisely mating design; and the pin 47 forms a rotary stop, against which the stop bearing washer 2, in particular the shoulder 45, can come into contact tangentially. This forms the rear stop of the tensioning module 1.

In the embodiment shown, the antirotation safeguard element 9 with attachment 46 and pin 47 are of monolithic or single-part design. However, multi-part embodiments are also conceivable and possible, for example embodiments in which the pin 47 is designed as a separate bolt and is plugged into the attachment.

FIGS. 9-13 show a further exemplary embodiment of a tensioning module 1.

FIG. 9 shows a sectional view of the further tensioning module 1.

FIG. 10 shows a drive unit of the spindle of the further tensioning module 1 from FIG. 9 in an oblique view.

FIG. 11 shows a drive unit of the spindle of the further tensioning module 1 from FIG. 9 in a further oblique view.

FIG. 12 shows a threaded portion of the spindle of the further tensioning module 1 from FIG. 9 in an oblique view.

FIG. 13 shows a securing element of the further tensioning module 1 from FIG. 9 in an oblique view.

In this embodiment of the invention, the drive portion 43 and the stop bearing washer 2 are formed as a common component, and an external spline system 61 is formed on one side of the stop bearing washer.

In other words, in this embodiment, the stop bearing washer 2 and the drive portion 43 are produced as a single, monolithic component.

For fastening and assembly, there can be provided a securing ring 18 which is pre-assembled as shown in FIG. 11. When the stop bearing washer 2 or the drive portion 43 is inserted into the internal spline system 62 of the threaded portion 42 of the spindle 4, the securing ring 18 can constrict into the groove on the stop bearing washer. After the stop bearing washer 2 has been inserted as far as it will go, the securing ring 18 will open. In this way, the stop bearing washer 2 can be axially secured with the threaded portion 42 of the spindle 4, and the torque can be transmitted via the spline systems according to the exemplary embodiment from FIG. 1.

The stop bearing washer 2 and the drive portion 43 also comprise a shoulder 45 with the same functionality as described above, i.e. a tangential rotary stop is thus formed between the stop bearing washer 2 and the nut 5. In addition, the stop bearing washer 2 also forms the running surface of the axial bearing 3.

In this exemplary embodiment, an alternative variant for the antirotation safeguard means of the ball screw drive is shown, which can of course also be used with the exemplary embodiment from FIG. 1.

In FIG. 9, a positive securing element 19, for example a nail or a pin, is provided for the antirotation safeguarding of the ball screw drive. The securing element 19 is shown in FIG. 13. The securing element 19 can be inserted into an opening 20 in the nut 5, as can be seen in FIG. 12. As a result, the nut 5 can be secured axially within the piston 7. For this purpose, the securing element 19 can comprise, for example, a circular portion which is inserted into an opening 20 of correspondingly mating design, which is embodied as a bore. The opposite portion of the securing element 19 can then be guided, for example, in a groove 21 in the housing 6. As a result, the nut 5 can be secured in relation to twisting relative to the housing 6.

As shown in FIG. 12, the nut 5 further has on the end surface a lug 22 as a rotary stop, against which the shoulder 45 of the stop bearing washer 2 comes into contact tangentially. This forms the rear stop of the tensioning module 1.

FIGS. 14-17 show yet a further exemplary embodiment of a tensioning module 1.

For this purpose, FIG. 14 shows a sectional view of a tensioning module 1 according to the yet further embodiment.

FIG. 15 shows a ball screw drive of the yet further embodiment of the tensioning module 1 in accordance with FIG. 14 without antirotation safeguard means.

FIG. 16 shows a stop bearing washer of the yet further embodiment of the tensioning module 1 from FIG. 14 in an oblique view.

FIG. 17 shows an outside view of the yet further embodiment of the tensioning module 1 from FIG. 14.

The spindle 4 is, as also shown in the first exemplary embodiment, configured in two parts with a drive portion 43 and a threaded portion 42. In this exemplary embodiment, the external spline system 61 is extended in the direction of the drive, as shown in FIG. 15. This makes it possible to create a positive fit with the stop bearing washer 2. For this purpose, the stop bearing washer 2, as shown in FIG. 16, is formed with a mating internal spline system 62 in the through hole. The stop bearing washer 2 can thus be plugged onto the external spline system 61 on the drive portion 43, as also shown in FIG. 17.

Thus, the torque can be transmitted via these spline systems, and the external spline system 51 of the nut 5 for the torque transmission between the stop bearing washer 2 and spindle 4 can be dispensed with.

The tensioning module 1 can be used in particular for an electromechanical brake device, for example an electromechanically actuable wheel brake, e.g. an electromechanically actuable disk brake.

The embodiments furthermore also includes a motor vehicle, comprising at least one electromechanical brake device of such type.

1. A tensioning module for an electromechanical brake device for a motor vehicle comprising
a ball screw drive;
a piston; and
an axial bearing;
wherein the ball screw drive comprises a spindle and a nut;
wherein the spindle comprises a threaded portion and a drive portion; and
wherein the threaded portion and the drive portion are produced as separate components and are connected to one another fixedly for conjoint rotation.

2. The tensioning module as claimed in claim 1, wherein the spindle is supported by the axial bearing in the housing.

3. The tensioning module as claimed in claim 1, further comprising a stop bearing washer, wherein the stop bearing washer is arranged at an axial end of a radial widening of the spindle, and wherein the axial bearing is arranged on the opposite side of the stop bearing washer to the piston.

4. The tensioning module as claimed in claim 3, wherein the stop bearing washer is arranged at a transition between the threaded portion and the drive portion.

5. The tensioning module as claimed in claim 1, wherein the stop bearing washer and the drive portion are formed as a one-piece, monolithic component.

6. The tensioning module as claimed in claim 1, wherein the threaded portion and the drive portion of the spindle are positively connected to one another, wherein one of: the threaded portion comprises an internal spline system on its drive-side region and the drive portion comprises an external spline system on its piston-side region.

7. The tensioning module as claimed in claim 1, wherein the threaded portion and the drive portion of the spindle are connected to one another in a non-positive manner.

8. The tensioning module as claimed in the preceding claim 1, wherein the threaded portion and the drive portion of the spindle are connected to one another in an integrally bonded manner.

9. The tensioning module as claimed in claim 1, wherein the stop bearing washer comprises an internal spline system.

10. The tensioning module as claimed in claim 9, wherein one of: the internal spline system of the threaded portion on the one hand and the external spline system of the drive portion and the stop bearing washer are of precisely mating design and in the mounted position are in an operative relationship to one another via the spline system.

11. The tensioning module as claimed in claim 10, wherein a press fit is provided between the internal spline system of the threaded portion on the one hand and the external spline system of the drive portion and/or the stop bearing washer.

12. The tensioning module as claimed in the preceding claim 1, wherein the drive portion has a smaller outside diameter than the threaded portion, so that an annular stop is formed which provides a piston-side stop surface for the stop bearing washer.

13. The tensioning module as claimed in the preceding claim 1, wherein the following relationship applies to the outside diameter D_{G} of the threaded portion of the spindle in comparison with the outside diameter D_{A} of the drive portion of the spindle: D_{G}>1.3*D_{A}, preferably D_{G}>1.5*D_{A}, particularly preferably D_{G}>1.7*D_{A}.

14. The tensioning module as claimed in the preceding claim 1, wherein a positive locking securing element is provided for antirotation safeguard of the ball screw drive.

15. The tensioning module as claimed in the preceding claim 1, wherein an antirotation safeguard element is provided which is preferably annular.

16. The tensioning module as claimed in the preceding claim 1, wherein the antirotation safeguard element comprises a radially projecting attachment which is received by a recess of the piston.

17. An electromechanical brake device, preferably an electromechanically actuable disk brake comprising:
a tensioning module;
a ball screw drive;
a piston; and
an axial bearing;
wherein the ball screw drive comprises a spindle and a nut;
wherein the spindle comprises a threaded portion and a drive portion; and
wherein the threaded portion and the drive portion are produced as separate components and are connected to one another fixedly for conjoint rotation; and
an electric motor connected to the spindle for driving the spindle.

18. The electromechanical brake device as claimed in claim 17, wherein the electromechanical brake device is on a vehicle.
